(19) United States
(12) Patent Application Publication
(10) Pub. No.: US 2007/0169136 A1
(43) Pub. Date: Jul. 19, 2007

(54) Optical disc drive apparatus, flexible printed circuit board joint structure, and joint structure of flexible printed circuit boards for optical pickup

(76) Inventors: Hiromichi Hiramatsu, Yokohama (JP); Hiroaki Furuichi, Kawasaki (JP); Satoshi Arai, Fujisawa (JP); Rika Nomura, Yokohama (JP); Mitsuo Satake, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/635,565

(22) Filed: Dec. 8, 2006

(30) Foreign Application Priority Data
Dec. 8, 2005 (JP) 2005-354677
Mar. 14, 2006 (JP) 2006-068734

(51) Int. Cl. G11B 7/00

(52) U.S. Cl. 720/658

(57) ABSTRACT

In a joint of a first flexible printed circuit board (FPC board) dividedly manufactured and fixed to an optical pickup device main body and a second FPC board dividedly manufactured and inserted into a drive side connector in an optical pickup drive apparatus, the present invention is characterized in that an end face of a base film of at least one of the FPC boards extends outward from an end face of wiring conductor. In solder bonding of a first FPC board to a second FPC board, the present invention is characterized by having a solder dam formed at a leading end of wiring of the first FPC board so as to ensure a predetermined amount of solder for re-joint when the second FPC board is removed from the first FPC board and by narrowing an end of wiring of the second FPC board.

### BACKGROUND OF THE INVENTION

1. Field of the Invention

The present invention relates to a thin optical pickup device used for reading from and writing to an optical disc such as a CD (compact disc) or a DVD (digital versatile disc), an optical disc drive apparatus incorporating the pickup device, a flexible printed circuit board joint structure, and a joint structure of flexible printed circuit boards for an optical pickup.

2. Description of the Related Art

Conventional techniques adopted in an optical disc drive apparatus and an optical pickup device incorporated in the optical disc drive apparatus are described in, for instance, Japanese Patent Laid-open Nos. 8-96390 (patent document 1) and 9-320078 (patent document 2).

Patent document 1 describes an optical pickup that takes out an output signal from a photo detector receiving a light beam returning from the surface of an optical disc and is supported by a biaxial actuator controllably driven by the outside. In the optical pickup, a flexible printed circuit board is disposed on the side surface of the optical pickup main body. In addition, a connection cord is connected to the flexible printed circuit board to transmit a driving control signal of the biaxial actuator and the output signal from the photo detector. The respective joints of the flexible printed circuit board and the connection cord are each formed with lands. The joint of the flexible printed circuit board is formed with the plurality of lands associated with respective signal lines connected to the connection cord. The joint (hereunder, referred to as the optical pickup side end) of the connection cord is formed with the plurality of lands each in contact with a corresponding one of the plurality of land formed on the flexible printed circuit board. The optical pickup side end of the connection cord is brought into pressure contact with the flexible printed circuit board provided on the side surface of the optical pickup by a pressing member made of an elastic material.

Patent document 2 describes a moving magnet type optical pickup in which a permanent magnet is wound around a lens holder adapted to hold an object lens. The optical pickup can improve assembly workability and reduce the number of parts by inserting a second pulling flexible printed circuit board into the hole of the flexible printed circuit board 1 energizing a coil, positioning them, and then subjecting the same to soldering work.

Japanese Patent Laid-open No. 2004-63356 (patent document 3) describes a flexible printed circuit board in which if the flexible printed circuit board has a complicate shape, a plurality of divided flexible printed circuit boards are fitted into or joined to each other, thereby increasing the yield from a raw plate material, that is, reducing the waste of the raw plate material.

Japanese Patent Laid-open No. 5-90748 (patent document 4) discloses a method of joining a flexible board to a printed circuit board. In this method, a side portion of the flexible board is projected, bent and connected to the rear surface of a conductor pattern joint of the printed circuit board opposite thereto. Thus, pulling and bending stress applied to the joint portion of the flexible board is released, whereby the boards can be joined together so as to have durability and resist peeling thereof.

Japanese Patent Laid-open No. 2005-276263 (patent document 5) describes an optical pickup joining method. In this method, a flexible board of an optical pickup is divided into two flexible boards, which are bonded together by soldering, thereby improving assembling workability of the flexible board, reducing the frequency of occurrence of failure, and realizing cost-reduction.

Japanese Patent Laid-open No. 6-85454 (patent document 6) discloses a method of solder bonding a flexible board to a rigid board. In this method, one of a pair of wiring boards overlapped partially each other is provided with a dam extending along an edge portion thereof. Thus, a fillet is formed at an end of solder between the wiring patterns of the pair of wiring boards, thereby increasing bonding strength.

### SUMMARY OF THE INVENTION

Along with the higher performance of the recent optical pickup device, a first portion of a printed circuit board (flexible board) fixed to the optical pickup device main body is increased in the density of signal wiring formed in the first portion. The printed circuit board is adapted to connect the main body to the drive side of an optical disc drive apparatus on which the main body is mounted. To deal with the increased density of signal wiring formed in the first portion, the first portion of the printed circuit board is formed as the so-called multilayered flexible board in which a plurality of layers formed with wiring are laminated while separated from one another with insulating films interleaved therebetween. Thus, the mounting area of the optical pickup device main body (area of the flexible board) is intentionally reduced. In contrast, at least a second portion of the printed circuited board to be inserted into a drive side connector and its vicinity (or a region extending from the second portion to a portion fixed to the optical pickup device main body) are formed as one layer (single layer) in which the wiring is collected up, to ensure its flexibility in order to deal with the movement of the optical pickup main body relative to the drive side connector. For this reason, the area of the second portion, for instance, inserted into the drive side connector and its vicinity is increased nearly two times that of the first portion fixed to the optical pickup device main body. Accordingly, if the printed circuit board provided with the multilayered wiring portion and the single-layered wiring portion is manufactured in an integral manner, in terms of cost there arises a major problem of reduced yield of the multilayered wiring portion.

The current flexible board having high performance tends to have a large number of pins, whose spacing is narrower. Accordingly, the positioning accuracy of the narrow spacing portion is stricter than the accuracy of the through-holes bored in the flexible board by the technique of patent document 1 described above. As a result, there is a problem of poor yield at the time of joint.

In the conventional technique of patent document 2 mentioned above, the second flexible board contains a portion on which component parts are mounted. Therefore, the second flexible board is manufactured by establishing integration of a portion to be inserted into a drive side connector and the portion on which chip components are mounted. This produces the same problem as described above.

The conventional techniques of patent documents 3 and 4 are effective for optical pickup devices having enough thickness. However, the so-called thin optical pickup device having reduced thickness is subjected to strict thickness-limitation. This poses a problem in that a connector cannot be attached to the flexible board in the optical pickup device.

The conventional structure of bonding the flexible boards as described in patent document 5 has a problem as below. When the divided and bonded flexible boards are repair-joined together, that is, when the solder bonding portion is reheated to melt and a second flexible board is removed, the melting solder moves unfavorably to the second flexible board removed. Therefore, an amount of solder required for re-bonding to the first flexible board cannot be ensured.

The conventional structure of bonding the flexible boards as described in patent document 6 has an object of increasing the bonding strength by providing a solder dam extending along the edge of one of the wiring boards to form a fillet at the end of the solder. Therefore, when the divided and bonded flexible boards are repair-joined together, that is, when the solder bonding portion is reheated to melt and one of the flexible boards is removed, it is difficult to prevent the solder from moving to the flexible board removed.

It is an object of the present invention to solve the above problems and provide an optical disc drive apparatus having a flexible printed circuit board (FPC board) that meets reduced thickness and performance required by a high-performance optical pickup device capable of reading from and writing to DVDs compliant to various specifications as well as CDs and that maintains reliability at low cost.

It is another object of the present invention to provide a flexible printed circuit board joint structure, a joint structure of flexible printed circuit boards for an optical pickup, and an optical disc drive apparatus, in which when one of the flexible printed circuit boards is removed from the other via a solder joint of the flexible printed circuit boards that have been solder bonded together, an amount of solder required for re-joint to one of the flexible printed circuit boards can be ensured to facilitate repair-joint, which significantly reduces poor joint between the flexible printed circuit boards, largely contributing to increased yield and reduced cost.

In order to achieve the above objects, an optical disc drive apparatus according to the present invention includes an optical pickup device main body on which a semiconductor chip component is mounted; an optical pickup case on which the optical pickup device main body is mounted and which is moved horizontally linearly in a reciprocative manner between inner and outer circumferential sides of an optical disc; and a first flexible printed circuit board manufactured by being divided from a second flexible printed circuit board and fixed to an upper surface of the optical pickup device main body, the first flexible printed circuit board being formed of a base film, a cover film and a wiring conductor sandwiched between the base film and the cover film, the second flexible printed circuit board being formed of a base film, a cover film and a wiring conductor sandwiched between the base film and the cover film and inserted into a drive side connector. In the optical disc drive apparatus, the wiring conductor located at a first joining end of the first flexible printed circuit board and the wiring conductor of the second flexible printed circuit board located at a second joining end are overlapped each other for positioning at a position near an end of an upper surface of the optical pickup case and bonded together using a bonding material to form a joint; and the joint is configured such that an end face of the base film at the joining end of at least one of the first and second flexible printed circuit boards extends outward from an end face of the associated wiring conductor.

In addition, the present invention has the following features: The extension has a length of about 1 mm or more. The first joining end and the second joining end are fixed so as to protect the bonding material with an adhesive. The adhesive is a thermosetting adhesive. The bonding material is made of solder plating. The wiring conductor of the first flexible printed circuit board has layers more than that of the wiring conductor of the second flexible printed circuit board. The wiring conductor of the second flexible printed circuit board is made of a single layer, whereas the wiring conductor of the first flexible printed circuit board is made of a plurality of layers. The joining portion is formed by pressing thereto a cover adapted to protect the optical pickup device main body attached to the optical pickup case.

According to the present invention, there is provided a flexible printed circuit board joint structure having a solder bonding portion formed by solder bonding wiring patterns formed at ends of a pair of divided flexible printed circuit boards, wherein a solder dam is formed at a leading end of the wiring pattern of at least one of the flexible printed circuit boards in order to ensure a predetermined amount of solder required for re-joint when one of the flexible printed circuit boards is removed from the other flexible printed circuit board by re-heating and melting the solder bonding portion.

The present invention has the following features: An end of the wiring pattern of the other flexible printed circuit board is narrowed in the solder bonding portion. A wiring width of the wiring pattern of the other flexible printed circuit board is made narrower than that of the one of the flexible printed circuit boards in the solder bonding portion. At least an end of the wiring pattern of the other flexible printed circuit board is split in the solder bonding portion.

According to the invention, there is provided a joint structure of flexible printed circuit boards for a thin optical pickup, having a solder bonding portion formed by solder bonding a first flexible printed circuit board fixed to an optical pickup device main body to a second flexible printed circuit board inserted into a drive side connector, wherein a solder dam is formed at a leading end of a wiring pattern of at least one of the first and second flexible printed circuit boards in order to ensure a predetermined amount of solder required for re-joint when the other of the first and second flexible printed circuit boards is removed from the one of the first and second flexible printed circuit boards by re-heating and melting the solder bonding portion.

The present invention has the following features: An end of the wiring pattern of the other of the first and second flexible printed circuit boards is narrowed in the solder bonding portion. A wiring width of the wiring pattern of the other of the first and second flexible printed circuit boards is made narrower than that of the one of the first and second flexible printed circuit boards in the solder bonding portion. At least an end of the wiring pattern of the other of the first and second flexible printed circuit boards is split in the solder bonding portion.

According to the present invention, there is provided an optical disc drive apparatus including: an optical pickup device main body on which a semiconductor chip component is mounted; and an optical pickup case on which the optical pickup device main body is mounted and which is moved horizontally linearly in a reciprocative manner between inner and outer circumferential sides of an optical disc; wherein the joint structure of flexible printed circuit boards for an optical pickup described above is placed between the optical pickup device main body and the drive side connector.

As described above, the present invention can realize a reduction in the thicknesses of an optical pickup device and an optical disc drive apparatus incorporating the pickup device and provide an optical disc drive apparatus having a flexible printed circuit board that meets performance required by a high-performance optical pickup device capable of reading and writing data from and to not only CDs but also DVDs compliant to various specifications and that maintains reliability at low cost.

According to the present invention, in the joint of the first flexible printed circuit board fixed to the optical pickup device main body on which the semiconductor chip component is mounted to the second flexible printed circuit board inserted to the drive side connector in the optical disc drive apparatus, the end face of the base film of at least one of the flexible printed circuit boards extends outward from the end face of the copper wiring. Therefore, the reduction in thickness is realized without increasing the thickness of the joint and the mechanical strength of the joint can be increased.

According to the present invention, in the solder bonding of the flexible printed circuit boards, when the other of the flexible printed circuit boards is removed from one of the flexible printed circuit boards, an amount of solder required for repair-joint to the one of the flexible printed circuit boards is ensured, facilitating the repair-joint. This significantly reduces the defective joint of the flexible printed circuit boards, largely contributing to improved yield and reduced cost.

According to the present invention applied to the joint structure of the flexible printed circuit boards dividedly manufactured in the thin optical pickup device, repair-joint work can be facilitated, which significantly reduces the defective joint of the flexible printed circuit boards, largely contributing to improved yield and reduced cost.

### BRIEF DESCRIPTION OF THE DRAWINGS

FIG. 1 is a perspective view of an optical disc drive apparatus according to the present invention in which a first flexible printed circuit board and a second flexible printed circuit board are divided at a traveling-directional end of an upper surface of an optical pickup case.

FIG. 2 is a perspective view of the optical disc drive apparatus according to the present invention in which the first flexible printed circuit board and the second flexible printed circuit board that have been divided are joined together at the traveling-directional end of the upper surface of the optical pickup case.

FIG. 3 is a cross-sectional view of the joint according to a first embodiment of the invention that is configured such that an end face of a base film provided outside at least one of the flexible printed circuit boards extends outward from a copper wiring end face and the joint is attached to the optical pickup case by pressing thereto a metal cover adapted to protect an optical pickup device main body.

FIG. 4 is a perspective view illustrating a state in which the optical pickup device according to the invention is assembled in the optical disc drive apparatus.

FIGS. 5A and 5B illustrate the movement of the flexible printed circuit boards in the optical pickup device according to the invention.

FIG. 6 is a cross-sectional view of a joint according to the first embodiment of the invention that is configured such that respective end faces of base films provided outside the first and second flexible printed circuit boards extend outward from corresponding copper wiring end faces and the joint is attached to the optical pickup case by pressing thereto a metal cover adapted to protect an optical pickup device main body.

FIG. 7 is a flowchart illustrating the schematic manufacturing process of the optical pickup device according to the present invention.

FIG. 8 illustrates the first flexible printed circuit board to be fixed to the optical pickup device main body according to the invention, mounted on a positioning jig not shown, in the first embodiment of the invention.

FIG. 9 illustrates a state in which the second flexible printed circuit board to be inserted into a drive side connector is positioned with respect to the first flexible printed circuit board illustrated in FIG. 8, in the first embodiment of the invention.

FIG. 10 illustrates a state in which an adhesive is applied to the joint as shown in FIG. 9, in the first embodiment of the invention.

FIG. 11 illustrates a state after the state shown in FIG. 10, in which a heating head is positioned at the joint, and then heated according to a predetermined temperature and time pattern, which causes the solder to melt, thus completing the bonding.

FIGS. 12A and 12B are explanatory diagrams of a positioning method involving superposing a first joining end of the first flexible printed circuit board on a second joining end of the second flexible printed circuit board according to a second example of the first embodiment of the invention.

FIGS. 13A and 13B are explanatory diagrams of a positioning method involving superposing a first joining end of the first flexible printed circuit board on a second joining end of the second flexible printed circuit board according to a third example of the first embodiment of the invention.

FIGS. 14A and 14B illustrate first respective shapes of the separate type flexible printed circuit boards according to the invention provided when plating is applied to the joints, a connector inserting portion and semiconductor chip component mounting pads.

FIGS. 15A and 15B illustrate second respective shapes of the separate type flexible printed circuit boards according to the invention provided when plating is applied to the joints, a connector inserting portion and semiconductor chip component mounting pads.

FIGS. 16A and 16B illustrate third respective shapes of the separate type flexible printed circuit boards' according to the invention provided when plating is applied to the joints, a connector inserting portion and semiconductor chip component mounting pads.

FIG. 17 is a perspective view illustrating a state in which a metal cover is attached to the optical pickup device so that the flexible printed circuit boards joined together as shown in FIG. 2 are not warped.

FIG. 18 is a cross-sectional view illustrating a state in which a first flexible printed circuit board according to a first example of a second embodiment in the present invention is positioned.

FIG. 19 is a cross-sectional view illustrating a state in which a second flexible printed circuit board and the first flexible printed circuit board according to the first example of the second embodiment in the present invention are positioned.

FIG. 20 is a cross-sectional view illustrating a state in which a heating head is positioned with respect to the first and second flexible printed circuit boards positioned as shown in FIG. 19.

FIG. 21 illustrates a state in which the second flexible printed circuit board is about to be removed from the first flexible printed circuit board by positioning a lower heater and re-heating the solder bonding portion to melt, with respect to the state shown in FIG. 20 according to the first example of the second embodiment in the invention.

FIGS. 22A and 22B are plan views illustrating the end of the second flexible printed circuit board and the end of the first flexible printed circuit board, respectively, according to a second example of the second embodiment in the invention.

FIGS. 23A and 23B are plan views illustrating the end of the second flexible printed circuit board and the end of the first flexible printed circuit board, respectively, according to a third example of the second embodiment in the invention.

FIGS. 24A and 24B are plan views illustrating the end of the second flexible printed circuit board and the end of the first flexible printed circuit board, respectively, according to a fourth example of the second embodiment in the invention.

### DETAILED DESCRIPTION OF THE PREFERRED EMBODIMENTS

### First Embodiment

Flexible printed circuit boards (FPC boards) and an optical pickup device according to a first embodiment of the present invention will be described with reference to the drawings.

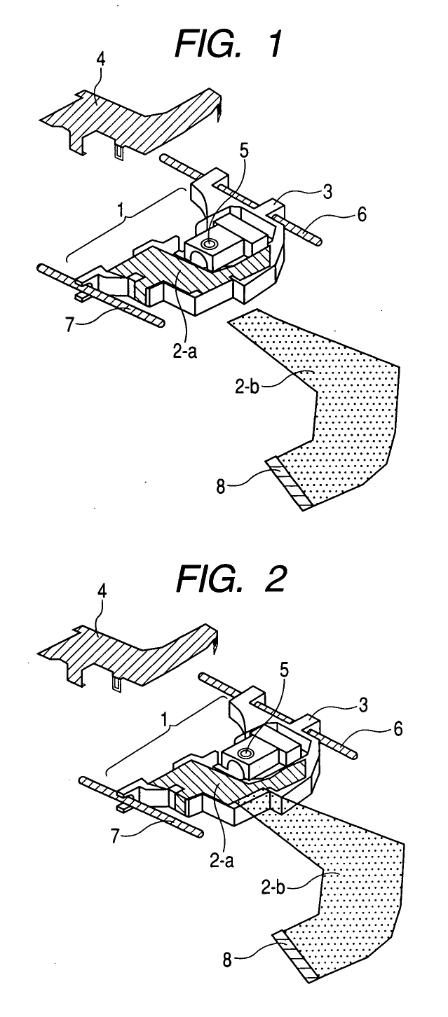

FIG. 1 is a perspective view of a flexible printed circuit board (FPC board) extending from an optical pickup device main body to a drive side connector in an optical desk drive apparatus according to the invention with the flexible printed circuit board (FPC board) divided into a first FPC board and a second FPC board at a traveling-directional end of an upper surface of an optical pickup case (a direction of being displaced relative to an optical disc (or the drive)). The first FPC board has two or more layers, places emphasis on high-density and is secured to the optical pickup main body and the second FPC board is single-layered, places emphasis on flexibility and is inserted into the drive side connector.

FIG. 2 is a perspective view illustrating a state in which the first and second FPC boards that has been divided are joined at the traveling-directional end of the upper surface of the optical pickup case in the optical disc drive apparatus according to the invention.

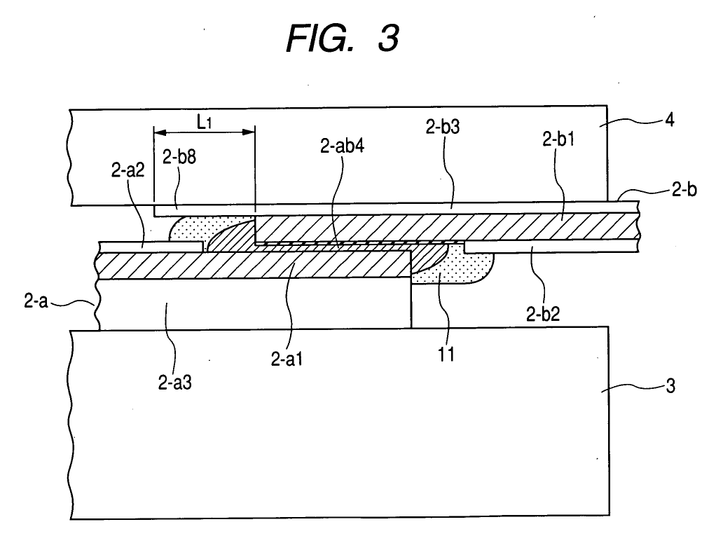

FIG. 3 is a cross-sectional view illustrating a state in which the joint, established as illustrated in FIG. 2, according to the present invention, is configured such that an end face of a base film provided on the outside of at least one of the FPC boards extends outward from the end face of the copper wire and the joint is attached to the optical pickup case by pressing thereto a metal cover adapted to protect the optical pickup device main body.

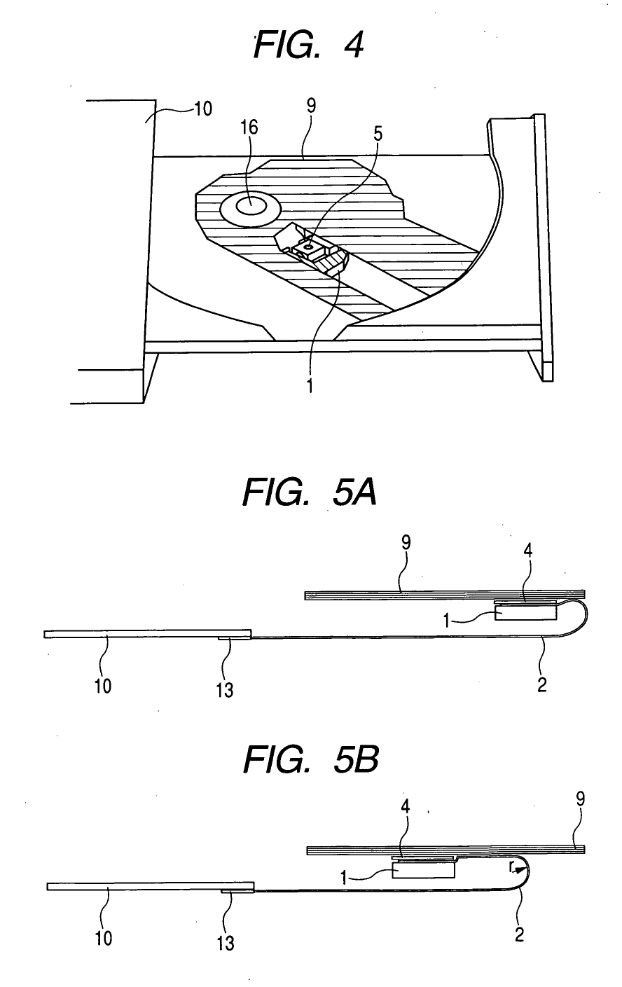

FIG. 4 is a perspective view illustrating a state in which the optical pickup device of the invention is built in the optical disc drive apparatus.

An optical desk drive apparatus 10 includes an optical pickup device main body 1 shown in FIGS. 1 and 2 (and a case 3 on which the main body 1 is mounted); and a unit provided with a circuit adapted to transmit and receive a signal to and from the optical pickup device main body and a driving device (shown as a rotor 16 to which an optical disc is fitted) called a drive rotating the optical disc. However, the detailed depiction of the unit is omitted. The optical pickup device main body 1 is opposed to an upward optical disc via a notched portion of a drive side cover 9 with an objective lens faced upward and reads and writes data from and to the disc while moving between the outer and inner circumferences of the disc. The optical pickup device main body 1 is displaced with respect to the drive along the groove of the drive side cover 9 illustrated in FIG. 4, that is, in a radial direction of the optical disc. In other words, the reciprocative traveling direction of the optical pickup device main body 1 is an axial direction of each of a primary shaft 6 and a secondary shaft 7 that carry part of the optical pickup case 3.

FIGS. 5A and 5B are side views illustrating the operation of the FPC board according to the present invention. In addition, FIG. 5A illustrates the optical pickup device moved to a position corresponding to the outmost circumference of the optical disc (accessing the outmost circumferential track) and FIG. 5B illustrates the optical pickup device moved to a position corresponding to the innermost circumference of the optical pickup device (accessing the innermost circumferential track).

Meanwhile, the optical disc drive apparatus incorporating a thin (thickness: 7 mm or less) optical pickup device or a thin optical disc drive apparatus used to read and/or write data from and/or to an optical disc such as a CD or a DVD has a structure as shown in FIGS. 1 to 4. More specifically, the optical pickup device includes the optical pickup case 3, the optical pickup device main body 1, and an optical system constituting components such as a light emitting element, various lenses, mirrors and a light-receiving element. The optical pickup case 3 is made from any one as a main ingredient selected from the group of Zn (zinc), Al (aluminum), Mg (magnesium) and a PPS (poly phenylene sulfide) resin by die-casting or by molding. In addition, the optical pickup case 3 is driven by the primary shaft 6 to travel along the secondary shaft 7 between the inner and outer circumferences of the optical disc in a liner and reciprocative manner. The optical pickup case device main body 1 is configured such that an LSI semiconductor chip component is mounted on the optical pickup case 3 so as to signal-process data read from or written to the optical disc. The FPC board may have a portion, as a sub FPC board, to be connected to optical modules such as a light emitting element and a light receiving element and an LSI semiconductor chip component.

As shown in FIG. 1, the FPC board extending from the optical pickup device main body 1 to the drive side connector inserting portion 8 is manufactured while divided into the first FPC board 2-a and the second FPC board 2-b at the traveling-directional end of the optical pickup case 3. The first FPC board 2-a is two or more layered (multi-layered) because of emphasis placed on high-density and is fixed to the optical pickup device main body. The second FPC board 2-b is single-layered because of emphasis placed on flexibility and is inserted into the drive side connector. As described above, various component parts should be arranged in the narrow optical pickup device main body horizontally and vertically at high density. Therefore, the FPC board having a complicate shape and serving to transmit a signal associated with the component parts is manufactured by being divided into the first FPC board 2-a placing emphasis on high-density and the second FPC board 2-b placing emphasis on flexibility.

While the second FPC board 2-b places emphasis on flexibility as described above, the optical pickup device needs to endure access several millions times. If the second FPC board 2-b uses a FPC board having a length of about 10 mm and a width of about 9 mm, it is desirable that the rigidity of the second FPC board 2-b be such that a reactive force is not less than 2.0×10⁻² N when the FPC board is bent to a radius of about 2 mm. Means for making the rigidity of the second FPC board 2-b lower than that of the first FPC board 2-a can also be achieved by making the second FPC board 2-b thinner than the first FPC board 2-a. In this case, it is desired that the second FPC board 2-b have a thickness of about 40 μm or more.

The first FPC board 2-a is multi-layered placing emphasis on high density. Therefore, the first FPC board can individually be fabricated by stamping out (cutting out) a sheet-like semifinished product composed of a large number of continuously arranged first FPC boards. This fabrication remarkably increases the yield of the first multi-layered FPC board to be fixed to the optical pickup device main body, largely contributing to cost reduction.

Meanwhile, the first FPC board 2-a thus dividedly fabricated is fixedly attached to the optical pickup device main body 1 at a portion near the objective lens 5 on the optical pickup case 3 while connected to the light emitting element, light receiving element and other various optical parts of the optical pickup device as shown in FIG. 1. Further, FIG. 1 shows a state in which the first FPC board 2-a fixed to the optical pickup device main body 1 is tested, and specifically a state after the light emitting element, light receiving element and other various optical parts of the optical pickup device has been subjected to an adjusting process. Incidentally, the testing method may involve using a probe pin or using a connector. As described above, since the optical pickup device is tested before connection to the second FPC board 2-b, an acceptable product at this stage is transferred to a subsequent process, thereby increasing yields.

The first FPC board 2-a and the second FPC board 2-b that have been dividedly fabricated are joined together at the ends thereof in a parallel manner so that the conductors thereof may overlap each other at the traveling-directional end of the optical pickup case 3 as shown in FIG. 2. Then, while the joint are pressed as shown in FIG. 3, the metal cover (the upper cover on the objective lens side) 4 having a limited height is attached to the optical pickup case 3 so as to protect the optical pickup device main body 1.

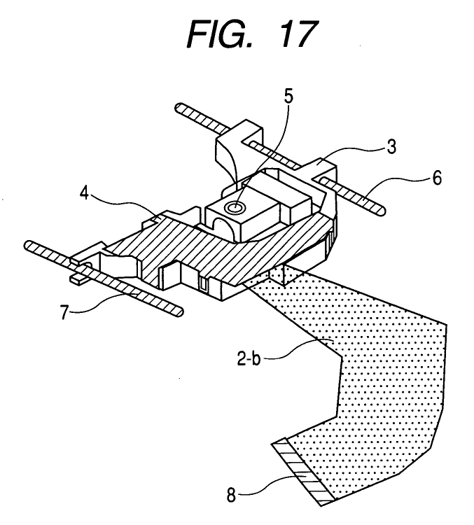

More specifically, the second FPC board 2-b places more emphasis on flexibility (for example, reduced in rigidity) than the first FPC board 2-a and has a joint end to be inserted into the drive side connector. The first FPC board 2-a is fixed to the optical pickup device main body at the traveling-directional end of the optical pickup case 3 and has a joint end. The joint end of the second FPC board 2-b and the joint end of the first FPC board 2-a are placed parallel to each other and pressed by the metal cover 4 while the wiring conductors thereof are overlapped each other, positioned (aligned) and connected by a bonding material as shown in FIGS. 3 and 17. In this way, the joint between the first FPC board 2-a and the second FPC board 2-b is pressed by the metal cover (the objective lens side upper cover) 4. When the optical pickup case 3 moves toward the inner or outer circumference of the optical disc as shown in FIGS. 5A and 5B, a load (for instance, small tensile stress applied to the second FPC board 2-b) may be repeatedly applied to the joint 2-ab4 between the first FPC board 2-a and the second FPC board 2-b. Even in this case, however, the first FPC board 2-a and the second FPC board 2-b can be prevented from peeling off from each other and also the second FPC board 2-b can be prevented from warping.

Incidentally, the first FPC board 2-a divided described above is fabricated in such a sheet-like manner that the wiring conductor portion 2-a1 made of copper foil or the like is sandwiched between insulating resin layers 2-a2 and 2-a3 containing polyimide and an adhesive. Likewise, the second FPC board 2-b divided described above is fabricated in such a sheet-like manner that the wiring conductor portion 2-b1 made of copper foil or the like is sandwiched between insulating resin layers 2-b2 and 2-b3 containing polyimide and an adhesive. FIG. 3 shows the joint end portion adapted to join the first FPC board 2-a to the second FPC board 2-b. The first FPC board 2-a is internally configured to have a multilayered wiring layer (multilayered portion is not shown) for connection with the LSI semiconductor chip components and the like.

The present invention adopts the divided structure for the FPC board and the joint portion is provided at the takeout portion of the optical pickup device main body, that is, at a portion near the end, as an exit, of the FPC board extending from the cover 4 to the drive side connector. In this case, since this portion is narrow in space, ten or more pins are often rowed up at a spacing as narrow as about 150 μm. As described above, since the optical pickup case 3 is increased in stroke distance to read and write data from and to the optical disc, the repeated bending load is applied to the wiring of the joined second FPC board. This needs to further reinforce the above-mentioned joint.

In order to reinforce the joint in the first embodiment of the present invention, the end face of the base film provided on outside of at least one of the FPC boards is extended to about 1 mm or more outward from the end face of the copper wiring. Preferably, it is extended to about 2 mm or more approximate to the bending radius.

For the configuration shown in FIG. 3, the second FPC board 2-b has a bending radius of about 2 mm shown in FIG. 5 and a thickness ranging from about 40 μm to about 100 μm. In addition, the end face of the base film 2-b3 provided on upper-side (outside) to constitute part of the second FPC board 2-b is extended to a length L1 equal to about 1 mm or more outward from the end face of the copper wiring 2-b1. Preferably, it is extended to about 2 mm or more approximate to the bending radius. Most preferably, it is extended to a position beyond the opening end of the cover film 2-a2 of the first FPC board 2-a. Additionally, a reference numeral 2-b8 shows a portion where the end face of the base film 2-b3 is extended outward from the end face of the copper wiring 2-b1. Alternatively, the end face of the base film 2-a3 provided on under-side (outside) to constitute part of the first FPC board 2-a that places more emphasis on high-density than the second FPC board 2-b may be extended to about 1 mm or more outward from the end face of the copper wiring 2-a1. Preferably, it may be extended to about 2 mm or more approximate to the bending radius. Most preferably, it may be extended to a position beyond the opening end of the cover film 2-b2 of the second FPC board 2-b. Additionally, a reference numeral 2-a8 shows a portion where the end face of the base film 2-a3 is extended outward from the end face of the copper wiring 2-a1.

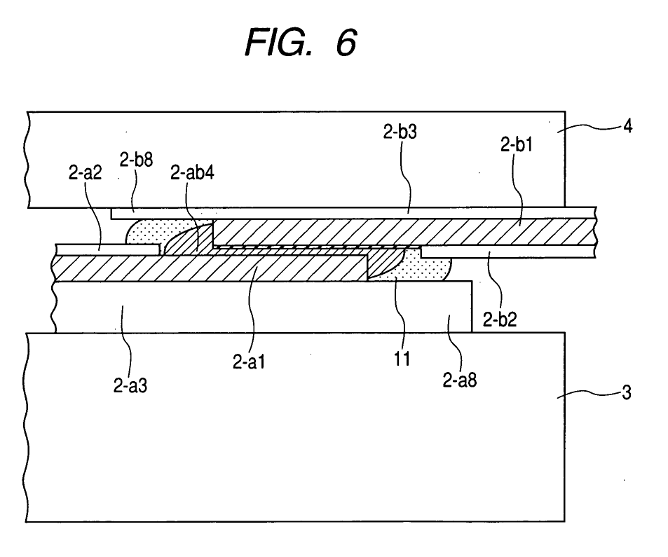

As shown in FIG. 6, the end face of the base film 2-b3 provided on the upper-side (the outside) to constitute part of the second FPC board 2-b is extended to about 1 mm or more outward from the end face of the copper wiring 2-b1. Preferably, it is extended to about 2 mm or more approximate to the bending radius. Most preferably, it is extended to a position beyond the opening end of the cover film 2-a2 of the first FPC board 2-a. Additionally, the end face of the base film 2-a3 provided on the under-side (the outside) to constitute part of the first FPC board 2-a placing more emphasis on high-density than the second FPC board 2-b may be extended to about 1 mm outward from the end face of the copper wiring 2-a2. Preferably, it may be extended to about 2 mm or more approximate to the bending radius. Most preferably, it may be extended to a position beyond the opening end of the cover film 2-b2 of the second FPC board 2-b.

As described above, the joint is configured such that the end face of the base film provided on at least one of the FPC boards extends outward from the end face of the copper wiring. This further reinforcement makes it possible to prevent the occurrence of peeling-off and poor joint even if a repeated bending load is applied to the wiring of the second FPC board joined every time data is read from and written to the optical disc. In addition, this further reinforcement makes it possible to provide a thin optical pickup device at low cost without increasing thickness of the joint.

The joint technique of the first FPC board (multilayered structure) and the second FPC board (single layered structure) according to the present invention can be mainly applied to a thin optical pickup device.

### FIRST EXAMPLE

A description will be made of a first example of a method of joining the first FPC board 2-a to the second FPC board 2-b according to the first embodiment of the present invention with reference to FIGS. 1 through 7.

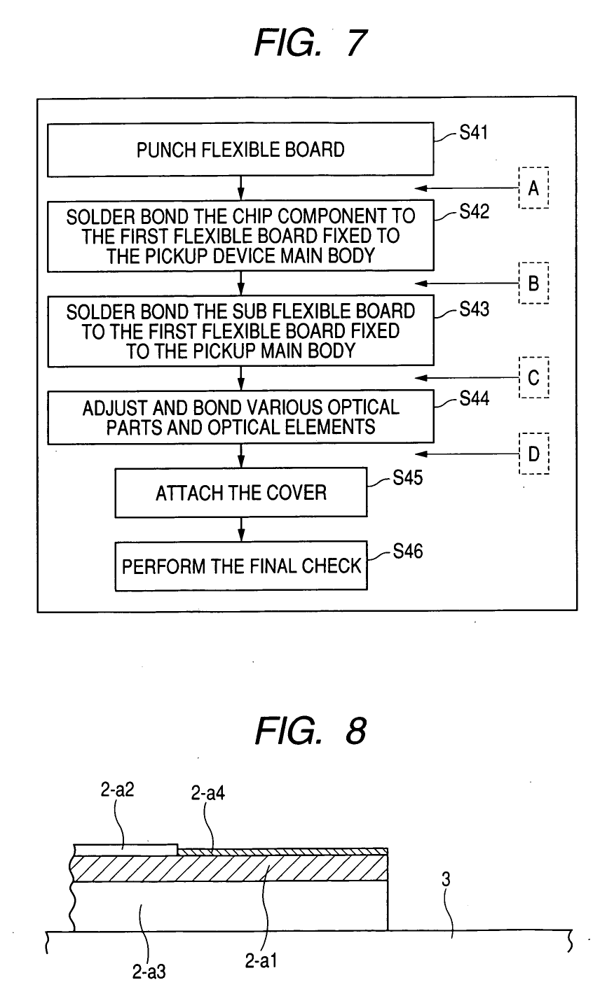

FIG. 7 is a flowchart illustrating the schematic manufacturing process of the optical pickup device according to the present invention.

The schematic manufacturing process of the optical pickup device includes the following steps (S41 through S45). In step S41 each of FPC boards delivered in a sheet-like manner is stamped out to each of first FPC board and second FPC board. In step S42, LSI chip components are fixedly bonded to the first FPC board 2-a to be finally fixed to the optical pickup device main body 1 with solder material such as solder paste or the like. Then reflow is carried out so that the LSI chip components are electrically connected to the first FPC board 2-a for mounting. Thereafter in step S43, a sub FPC board having a light emission element and a light receiving element connected thereto is solder bonded to the first FPC board 2-a to be finally fixed to the optical pickup device main body. In step S44, then various optical components are adjusted and bonded. In a step indicated by any one of symbols A to D, the second FPC board 2-b is joined to the first FPC board 2-a. Thereafter, in step S45, the metal cover is attached to protect the optical pickup device main body 1. Thereafter in step S46, a final check is carried out.

The step of joining the first FPC board 2-a to the second FPC board 2-b should be carried out in the order indicated by any one of symbols A to D shown in FIG. 7. Symbol A is after step 41, B is after step 42, C is after step 43 and D is after step S44. If the above-mentioned joining step is executed at the end as indicated by symbol D, the defective appearance of the second FPC board encountered in the middle of the steps can be reduced significantly. This makes it possible to remarkably increase the yield of the entire optical pickup device.

In this way, while the joining of the first FPC board to the second FPC board may be performed in the order of any one indicated by symbols A, B, C and D, the case of symbol D has been described.

### SECOND EXAMPLE

Next, a detailed description will be made of a second example of a joint between the first FPC board 2-a and the second FPC board according to the first embodiment of the invention with reference to FIGS. 8 through 11 as cross-sectional views. FIG. 8 illustrates the first FPC board 2-a to be fixed to the optical pickup device main body, mounted on a positioning jig not shown. The first FPC board 2-a is configured such that wiring copper foil 2-a1 is bonded to the base film 2-a3 via an adhesive not shown. In this case the description is made using the first FPC board 2-a in which the end face of the base film 2-a3 is flush with the end face of the wiring copper foil 2-a1. The cover film 2-a2 is bonded to the wiring copper foil 2-a1 with an adhesive not shown so as to cover the surface of the wiring copper foil 2-a1. A region where the cover film 2-a2 is absent on the wiring copper foil 2-a1 is used to mount semiconductor chip components not shown or to establish connection with the second FPC board 2-b. Solder plating 2-a4 is applied to this region in order to facilitate connection with component parts or the matching FPC board.

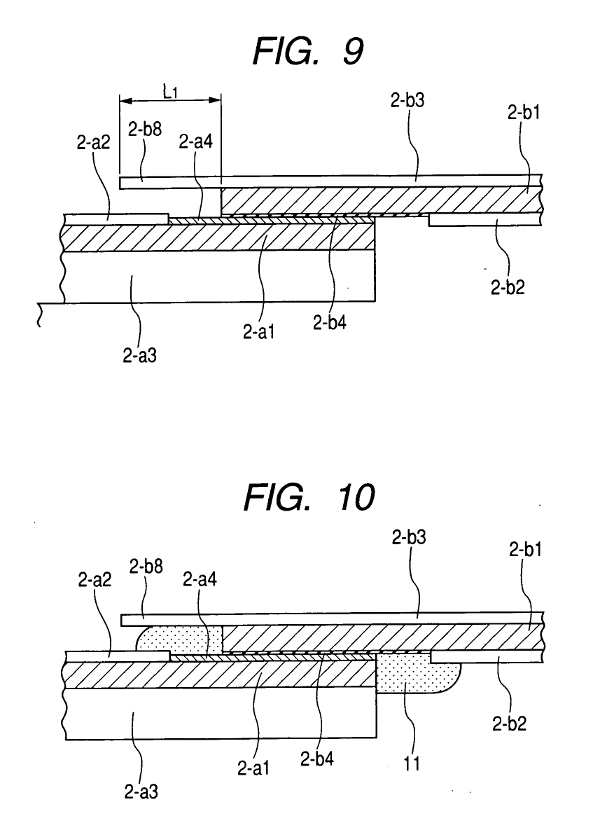

FIG. 9 illustrates a state in which the second FPC board 2-b to be inserted to the drive side connector is positioned (aligned) with respect to the first FPC board 2-a illustrated in FIG. 8 that is mounted on the positioning jig not shown and is to be fixed to the optical pickup device main body. Similarly to the first FPC board 2-a, the second FPC board 2-b is configured such that the wiring copper foil 2-b1 is bonded to the base film 2-b3 with an adhesive not shown. The cover film 2-b2 is bonded to the wiring copper foil 2-b1 with an adhesive not shown so as to cover the surface of the wiring copper foil 2-b1.

According to the feature of the second example, in order to reinforce the joint to which a repeated bending load is applied, the second FPC board 2-b is used in which the end face of the base film 2-b3 is extended to a length L1 of about 1 mm or more from the end face of the wiring copper foil 2-b1. A region on which the cover film 2-b2 is absent on the wiring copper foil 2-b1 is used to establish connection with the first FPC board 2-a. Solder plating 2-b4 is applied to the region so as to facilitate connection with the matching FPC board. A combination of the same materials or different materials for the solder plating 2-a4 and 2-b4 is selected depending on performance required before and after the bonding. The solder plating 2-a4 and 2-b4 having the thus-selected combination of the materials are applied to the surfaces of the wiring copper foil 2-a4 and 2-b4, respectively.

As shown in FIGS. 12A and 12B, a positioning method performed in this case involves superposing the wiring portion 2-a4 of the first FPC board 2-a on the wiring portion 2-b4 (on the back side) of the second FPC board 2-b and judging misalignment that may result from the superposition.

FIG. 10 illustrates a state in which an adhesive 11 is applied to the joint portion as shown in FIG. 9. In this case, after the first and second FPC boards 2-a and 2-b are positioned, the gaps therebetween is filled with the adhesive 11. However, because of limited process order and easy application, the positioning may be made after the first and second FPC boards 2-a and 2-b are preliminarily applied with the adhesive.

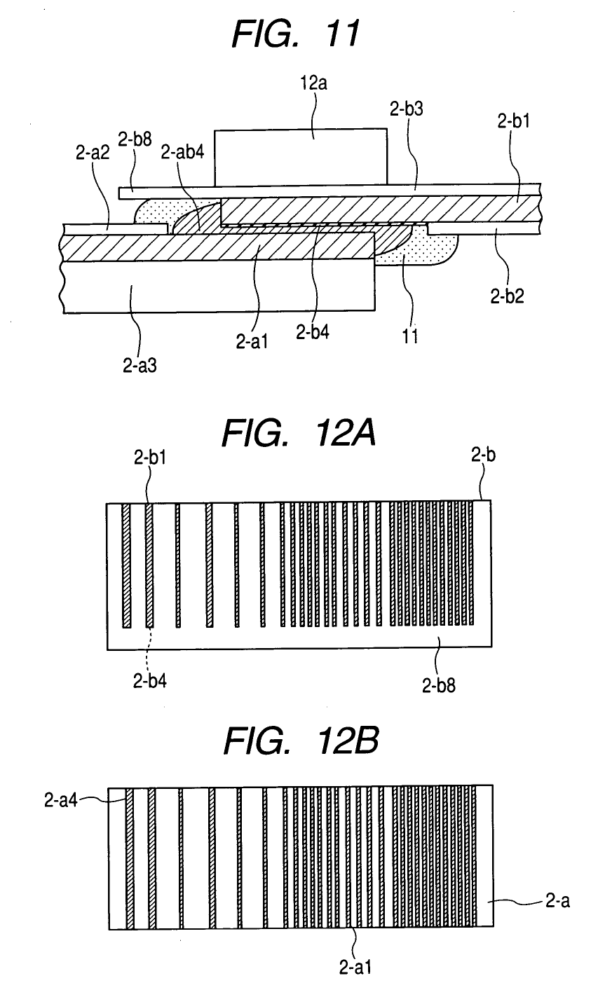

FIG. 11 illustrates a state after the state shown in FIG. 10. In this state, a heating head 12 is positioned at the joint portion and then is heated according to a predetermined temperature and time pattern. This heating causes the solder to melt, thus completing the bonding. Each of the solder joint portions 2-ab4 is formed as shown in FIG. 11 by bonding between each of the solder plating 2-a4 and each of the solder plating 2-b4 as come in contact as shown in FIG. 10, when the solders melt, and each of fillets is formed on the each end face of the wiring copper foils 2-a1 and the each end face of the wiring copper foils 2-b1 by wetly seeping the solder as well as the each end face of the wiring copper foils 2-a1 and the each end face of the wiring copper foils 2-b1. In this case, use of a thermosetting adhesive 11 can proceed curing of the adhesive simultaneously with melting of the solder. While the adhesive is cured simultaneously with melting of the solder, it is possible to further improve the strength by heating the adhesive in another process. The heating head uses a thermo-compression bonding type in this case. However, the same effect can be achieved by a method of using a press jig formed with a window at a position corresponding to only the joint portion and applying heat toward the window (for instance, laser heating).

Incidentally, a silicon-based or epoxy-based adhesive is used for the thermosetting adhesive. Because flexibility is required in the invention, the soft silicon-based adhesive is mainly used. However, even an epoxy-based adhesive can selectively be used if it has a coefficient of elasticity that meets use conditions.

Then, the heating head 12 is released from the first and second FPC boards 2-a, 2-b and the first FPC board 2-a is removed from the positioning jig not shown and disposed thereunder, thus completing the bonding process.

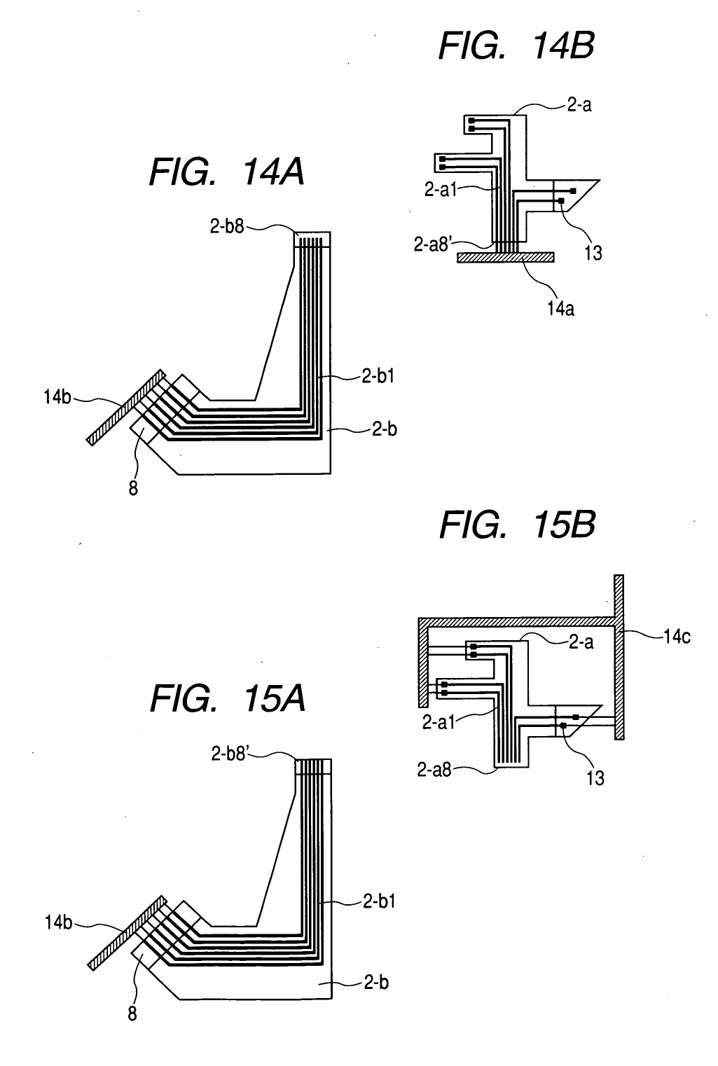

The description is made of the second embodiment in which the base film of the second FPC board 2-b disposed on the upper side in the figures is extended. Next, a description is made of how to select the base film of the first or second FPC boards with reference to FIGS. 14A, 14B, 15A and 15B. FIGS. 14A and 14B illustrate first respective shapes of the separate type FPC boards 2-a, 2-b when plating is applied to the joints 2-a4, 2-b4, the connector inserting portion 8 and a semiconductor chip component mounting pads 13. Electric supply circuits 14a and 14b for applying solder plating are connected to the wiring copper foil 2-a1 and 2-b1, respectively. In this case, for the first FPC board 2-a as shown in FIG. 14B, the electric supply circuit 14a is connected to a bonding portion 2-a8′ on the side opposite the pad 13. For the second FPC board 2-b as shown in FIG. 14A, the electric supply circuit 14b is connected to the connector inserting portion 8. In this way, after application of plating, the electric supply circuit 14a is cut off when the separate type FPC board 2-a is externally stamped out, and similarly, the electric supply circuit 14b is cut off when the separate type FPC board 2-b is externally stamped out. As a result, in a cross-section of portion 2-a8′ and in a cross-section of the connector inserting portion 8 close respectively to the electric supply circuits 14a and 14b, the end faces of the base film are flush with the end faces of the wiring copper foil. Thus, a portion 2-b8 on the side opposite the portion close to the electric supply circuit in the second FPC board 2-b can be located on the side where the end face of the base film is extended. As shown in FIG. 3, the joint in which the end face of the base film extends from the end face of the wiring copper foil can be achieved in the second FPC board 2-b.

FIGS. 15A and 15B illustrate second respective shapes of the separate type FPC boards 2-a, 2-b of the first embodiment when plating is applied to the joints 2-a4, 2-b4, the connector inserting portion 8 and the semiconductor chip component mounting pad 13. An electric supply circuit 14c for applying solder plating is connected to the wiring copper foil 2-a1, and similarly, the electric supply circuit 14a for applying solder plating is connected to the wiring copper foil 2-b1. In this case, as shown in FIG. 15B, the electric supply circuit 14c is connected to semiconductor chip component mounting pads 13 in the first FPC board 2-a. As shown in FIG. 15A, the electric supply circuit 14b is connected to the connector inserting portion 8 in the second FPC board 2-b. In this way, after application of plating, the electric supply circuit 14c is cut off when the separate type FPC board 2-a is externally stamped out, and similarly, the electric supply circuit 14b is cut off when the separate type FPC board 2-b is externally stamped out. As a result, in cross-section of portions close to the electric supply circuit 14c and in a cross-section of the connector inserting portion 8 close to a portion of the electric supply circuit 14b, the end faces of the base film are flush with the end faces of the wiring copper foil. Thus, a portion 2-a8 on the side opposite the portion close to the electric supply circuit 14c in the first FPC board 2-a can be located on the side where the end face of the base film is extended.

Meanwhile, the reciprocating movement of the optical pickup device between the outer and inner circumferences of an optical disc applies a bending load to the FPC board. Design is needed to bring the bending point of this case to a position outside the joint portion of the FPC board. Further, because of manufactural restriction on the FPC board, each of the first and second FPC boards needs to position solder plating-applied surfaces on any one of the front and back thereof. Accordingly, which mode of FIG. 14 or 15 is selected is finally determined depending on a combination of the front and back of a connector side connected to the drive and associated with the above-mentioned restriction and user's request, and the front and back of the inner side on which a semiconductor chip component is mounted. Also in the case of extending only one base film, if the adhesive 11 is filled in a portion near the not-extended joint, the effect approximately equal to that of the base film extension can be obtained.

Because of no restriction on the wiring pattern, any base film may be extended in some cases. In this case, the end face of the base film opposite to a side to which the bending load tends to be applied extends from the end face of the wiring copper foil. This is more effective in reinforcing the base film opposite thereto.

### THIRD EXAMPLE

FIG. 6 illustrates a third example of the first embodiment according to the present invention. In FIG. 3, only the end face of the base film 2-b3 of the FPC board 2-b extends from the end face of the wiring copper foil 2-b1. However, in FIG. 6, also the end face of the base film 2-a3 of the FPC board 2-a extends from the end face of the wiring copper foil 2-a1. Each of the solder joint portions 2-ab4 is formed as shown in FIG. 6 by bonding between each of the solder plating 2-a4 and each of the solder plating 2-b4 as come in contact as shown in FIG. 3, when the solders melt, and each of fillets is formed on the each end face of the wiring copper foils 2-a1 and the each end face of the wiring copper foils 2-b1 by wetly seeping the solder as well as the each end face of the wiring copper foils 2-a1 and the each end face of the wiring copper foils 2-b1.

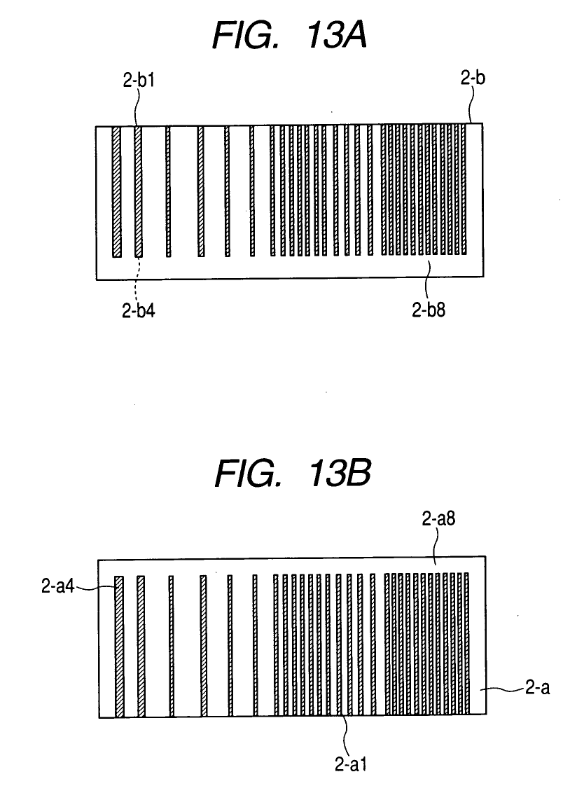

As shown in FIGS. 13A and 13B, a positioning method performed in this case involves superposing the wiring portion 2-b4 (on the back side) of the second FPC board 2-b on the wiring portion 2-a4 of the first FPC board 2-a and judging misalignment that may result from the superposition.

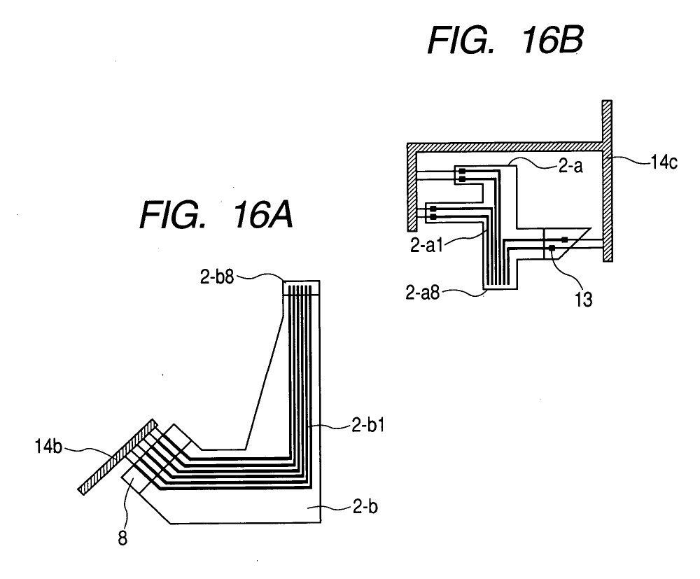

FIGS. 16A and 16B illustrate third respective shapes of the separate type FPC boards 2-a, 2-b when plating is applied to the joints 2-a4, 2-b4, the connector inserting portion 8 and a semiconductor chip component mounting pads 13. Electric supply circuits 14c and 14b for applying solder plating are connected to the wiring copper foil 2-a1 and 2-b1, respectively. In this case, for the first FPC board 2-a as shown in FIG. 16B, the electric supply circuit 14c is connected to the pads 13. For the second FPC board 2-b as shown in FIG. 16A, the electric supply circuit 14b is connected to the connector inserting portion 8. In this way, after application of plating, the electric supply circuit 14c is cut off when the separate type FPC board 2-a is externally stamped out, and similarly, the electric supply circuit 14b is cut off when the separate type FPC board 2-b is externally stamped out. As a result, in a cross-section of portions close to the electric supply circuit 14c and in a cross-section of the connector inserting portion 8 close to the electric supply circuit 14b, the end faces of the base film are flush with the end faces of the wiring copper foil. Thus, a portion 2-a8 on the side opposite the portion close to the electric supply circuit 14c in the first FPC board 2-a can be located on the side where the end face of the base film is extended and a portion 2-b8 on the side opposite the portion close to the electric supply circuit 14b in the second FPC board 2-b can be located on the side where the end face of the base film is extended.

With the configuration described above, as shown in FIG. 6, since the base films 2-a3 and 2-b3 are disposed to cover the wiring copper foil 2-a1 and 2-b1, respectively, on the joint, secure reinforcement can be enabled. In addition, during the period of use of the optical pickup device, it possible to more positively prevent short circuit caused by foreign material adhering to the wiring copper foil 2-a1, 2-b1.

As described above, according to the first embodiment, at least one end face of the base film extends outward from the end face of the copper wiring at the joint between the first FPC board fixed to the optical pickup device main body mounted with the semiconductor chip component and the second FPC board inserted to the drive side connector in the optical disc drive apparatus. Therefore, the optical pickup device can be reduced in thickness without increasing the thickness of the joint while increasing the mechanical strength of the joint. Since subsidiary materials for reinforcement can be eliminated, the process for reinforcement and the costs for the subsidiary materials and the like can be eliminated, which can prevent an increase in comprehensive initial cost, realizing low cost.

According to the first embodiment, since the thermosetting adhesive is selectively used to fix the base films opposite to each other, the base films can be bonded together simultaneously with the joint of the first FPC board and the second FPC board by heat of the heating head for joining the boards. This can prevent an increase in process.

According to the first embodiment, the joined conductor portion is covered by at least one of the end faces of the base films extending externally from the end face of the copper wiring. Therefore, this can prevent the heating head used for thermo-compression bonding from coming contact with the melting solder to get dirty, thereby facilitating maintenance of the heating head. Since the surface of the conductor portion is covered, it is possible to prevent short circuit caused by foreign material adhering to the conductor portion during the period of use of the optical pickup device.

According to the first embodiment, since a weak portion, that is, the joint between the first and second FPC boards is reinforced and protected in the optical pickup device, reliability and durability can be enhanced. Further, the component parts are reinforced without significantly modifying the FPC board, contributing to the reduced cost of the entire optical pickup device.

### Second Embodiment

Next, a description will be made of a flexible printed circuit board joint structure, a joint structure of flexible printed circuit boards (FPC boards) for an optical pickup and an optical disc drive apparatus according to a second embodiment of the present invention with reference to the drawings.

The optical disc drive apparatus according to the second embodiment of the invention are configured similarly to that of the first embodiment shown in FIGS. 1, 2, 4 and 5. The schematic manufacturing processes of the optical pickup device according to the second embodiment is the same as that of first embodiment shown in FIG. 7.

Meanwhile, as described in the first embodiment, the divided structure for the FPC board is adopted and the joint portion is provided at the portion in which the optical pickup device main body is taken out, that is, at a portion near the end, as an exit, of the FPC board leadable from the cover 4 to the drive side connector. In this case, since this portion is narrow in space, ten or more pins are often rowed up at a spacing as narrow as about 150 μm.

Further, solder is applied to the joint between the first FPC board 2-a and the second FPC board 2-b divided as describe above. In this case, if the second FPC board has failure and instead a new FPC board is joined again, a method is taken for heating and melting the solder joint portions and thereby removing the second FPC board from the joint of the FPC boards. In this case, an amount of solder must be ensured that is required for rejoining the new FPC board to the first FPC board 2-a fixed to the optical pickup main body 1 so that melting solder does not move to the second FPC board, thus facilitating the re-joint therebetween. In short, in order to improve the yield of the products and reduce cost, a structure is needed that facilitates the repair-joint between the FPC boards.

To meet the above-mentioned need, the second embodiment of the invention provides a thin optical pickup device in which a first FPC board 2-a disposed inside a pickup and a second FPC board 2-b disposed outside the pickup are divided from each other and joined together. This optical pickup device is characterized in that a solder film 2-a4 is formed on the first FPC board 2-a and a solder dam portion 2-a5 comprising an insulating material (e.g., the same material as that of a cover film) is disposed at a tip (leading end) of the wiring (wiring pattern) 2-a1 of the first FPC board 2-a. Thus, when the second FPC board 2-b is removed from the first FPC board 2-a through a heating and melting process, an amount of solder required for the first FPC board 2-a during repair joint can be ensured by the solder dam 2-a5.

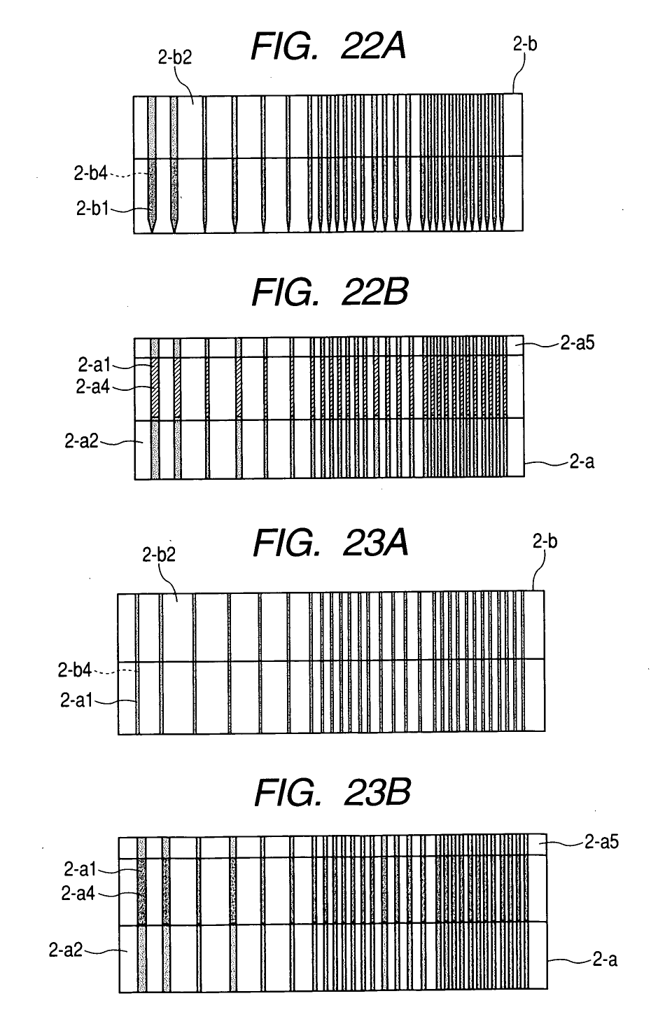

The second embodiment of the present invention is characterized by the following. As shown in FIG. 22, the second FPC board 2-b has wiring (wiring pattern) 2-b1 whose tip is narrowed. This narrowed tip can prevent solder from moving to the second FPC board 2-b when the second FPC board 2-b is removed from the first FPC board 2-a through a heat-melting process. Thus, an amount of solder required for repair-joint to the first FPC board 2-a can be ensured.

The second embodiment of the present invention is characterized in that solder is prevented from moving to the second FPC board 2-b by making the width of the wiring (wiring pattern) of the second FPC board 2-b narrower than that of the wiring (wiring pattern) 2-a1 of the first FPC board 2-a as shown in FIGS. 23A and 23B.

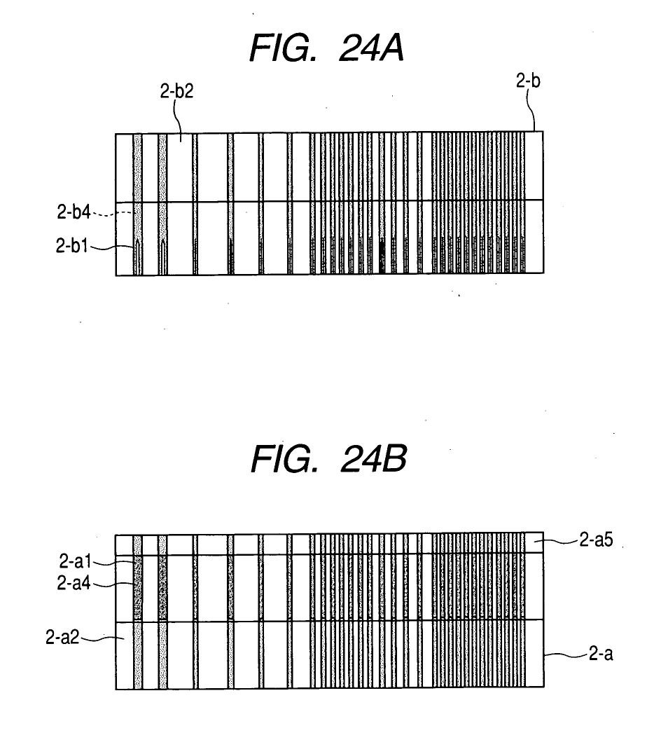

The second embodiment of the present invention is characterized in that solder is prevented from moving to the second FPC board 2-b by splitting the end portion of the wiring (wiring pattern) 2-b1 of the second FPC board 2-b as shown in FIG. 24.

The above description has been made of ensuring the amount of solder required for repair-joint on the first FPC board. In contrast, if the amount of solder is ensured on the second FPC board, it is needed only to provide the above-described structure on the second FPC board.

Incidentally, the joint technique of FPC boards according to the present invention described above is mainly applied to the thin optical pickup device. However, the joint technique can be applied to other products having FPC boards joined to each other.

### FIRST EXAMPLE

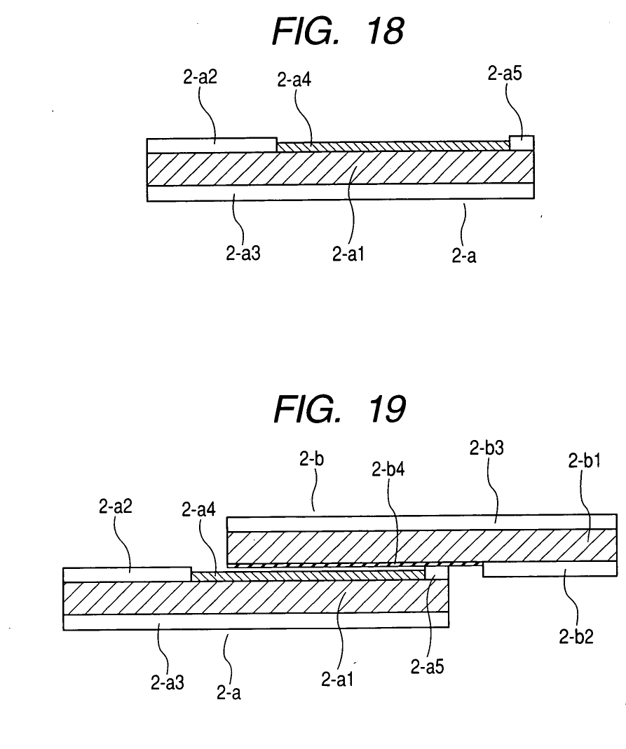

Next, a detailed description is made of a first example of facilitating repair joint characterizing the second embodiment of the present invention with reference to FIG. 21 as a cross-sectional view of a joint. FIG. 18 illustrates a first FPC board 2-a to be fixed to an optical pickup device main body, mounted on a positioning jig not shown. The first FPC board 2-a is configured such that wiring copper foil (wiring pattern) 2-a1 is bonded to a base film 2-a3 via an adhesive not shown. Here, a description is made of a state in which the FPC board 2-a is used which has a solder dam 2-a5 formed of the same material as that of a cover film and bonded to the tip (leading end) of wiring copper foil 2-a1.

The cover film 2-a2 is bonded to the wiring copper foil 2-a1 with an adhesive not shown so as to cover the surface of the wiring copper foil 2-a1. The solder dam 2-a5 is bonded to the tip (leading end) of the wiring copper foil 2-a1 in the following manner. Similarly to the cover film 2-a2, the solder dam 2-a5 is superposed and bonded to the end portion of the wiring copper foil 2-a1 so as to cover the surface thereof, then cut from above while being aligned with the end portion of the FPC board 2-a, and is left there (not shown).

Preferably, the thus-superposed solder dam 2-a5 has a length of 0.4 to 2.0 mm from the end of the first FPC board 2-a taking into account the following. In general, displacement of the cover film 2-a2 when the cover film is bonded is ±0.2 mm, the solder dam 2-a5 should not peel off from the FPC board 2-a, shift (movement) should not occur when the solder dam 2-a5 is cut, and deviation may be given when the solder dam is cut.

The solder dam 2-a5 has a thickness of 20 to 40 μm if the adhesive has a thickness of 10 to 20 μm and the cover film 2-a2, 2-a3 each has a thickness of 10 to 20 μm, for instance.

A region where the cover film 2-a2 is absent on the wiring copper foil 2-a1 of the first FPC board 2-a is used to mount semiconductor chip components not shown or to establish connection with the second FPC board 2-b. Solder plating 2-a4 is applied to this region in order to facilitate connection with component parts or the mating board.

FIG. 19 illustrates a state in which the second FPC board 2-b to be inserted to the drive side connector is positioned with respect to the first FPC board 2-a illustrated in FIG. 18 that is mounted on the positioning jig not shown and is to be fixed to the optical pickup device main body. Similarly to the first FPC board 2-a, the second FPC board 2-b is configured such that the wiring copper foil 2-b1 is bonded to the base film 2-b3 with an adhesive not shown. The cover film 2-b2 is bonded to the wiring copper foil 2-b1 with an adhesive not shown so as to cover the surface of the wiring copper foil 2-b1.

A description is made of a state where the FPC board 2-b is used which has the cover film 2-b2 bonded to the wiring copper foil 2-b1. A region on which the cover film 2-b2 is absent on the wiring copper foil 2-b1 is used to establish connection with the first FPC board 2-a. Solder plating 2-b4 is applied to the region so as to facilitate connection with the matching board. A combination of the same materials or different materials for the solder plating 2-a4 and 2-b4 is selected depending on performance required before and after the bonding. The solder plating 2-a4 and 2-b4 having the thus-selected combination of the materials are applied to the surfaces of the wiring copper foil 2-a4 and 2-b4, respectively.

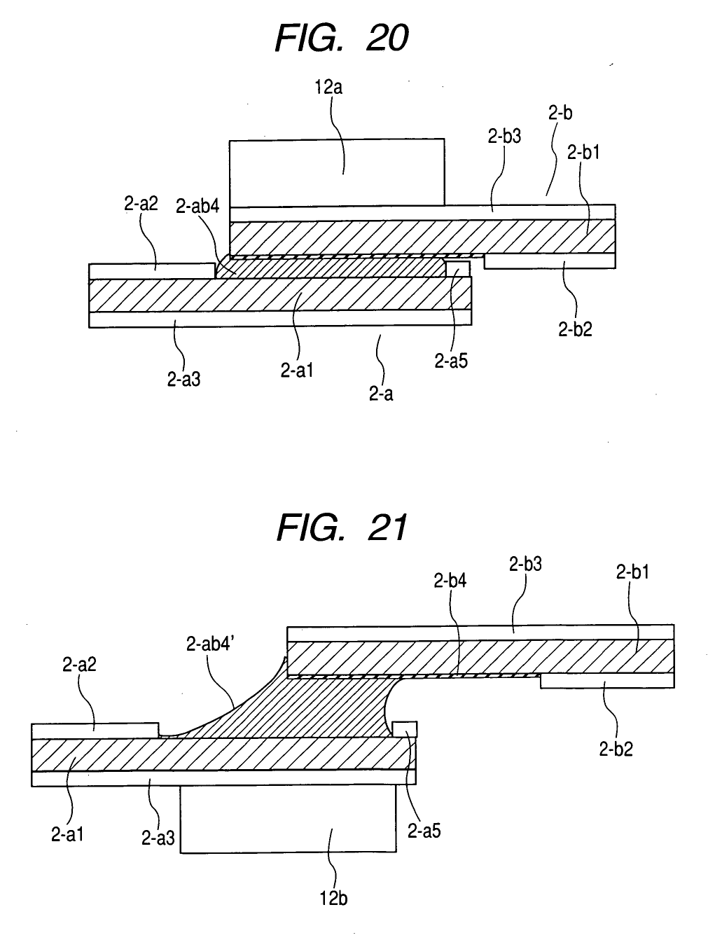

FIG. 20 illustrates a state in which a heating head 12a is positioned at the joint portion and then is heated according to a predetermined temperature and time pattern. This heating causes the solder to melt, thus completing the bonding. Each of the solder joint portions 2-ab4 is formed as shown in FIG. 20 by bonding between each of the solder plating 2-a4 and each of the solder plating 2-b4 as come in contact as shown in FIG. 19, when the solders melt, and each of fillets is formed on the each end face of the wiring copper foils 2-a1 and the each end face of the wiring copper foils 2-b1 by wetly seeping the solder as well as the each end face of the wiring copper foils 2-a1 and the each end face of the wiring copper foils 2-b1. The heating head uses a thermo-compression bonding type in this case. However, the same effect can be achieved by a method of using a press jig formed with a window at a position corresponding to only the joint portion and applying predetermined heat toward the window (for example, laser heating).

Then, the heating head 12a is released from the first and second FPC boards 2-a, 2-b and the first FPC board 2-a is removed from the positioning jig not shown and disposed thereunder, thus completing the bonding process.

In contrast to the state shown in FIG. 20, FIG. 21 illustrates a state in which the solder bonded portion between the FPC boards 2-a and 2-b are re-melted by a lower heater 12b and the FPC board 2-b is removed. When the second FPC board 2-b is removed from the first FPC board 2-a by melting the solder, the solder 2-a4′ moves to the respective corresponding ends of the FPC board 2-a and 2-b. In this case, the solder dam 2-a5 of the first FPC board 2-a has an effect of leaving the melting solder 2-ab4′ on the side of the first FPC board 2-a. This effect can ensure an amount of solder required for re-joint to the first FPC board 2-a, facilitating repair-joint.

Incidentally, the solder dam 2-a5 uses the same material as that of the cover film 2-a2 in view of manufacture in this example. However, an insulating material for a resist process, an adhesive or the like may be used for the solder 2-a5. While formed on one of the FPC boards in this example, the solder film may be formed on both the FPC boards.

### SECOND EXAMPLE

Next, a description is made of a second example of facilitated repair-joint that features the second embodiment of the present invention with reference to FIGS. 22A and 22B. FIGS. 22A and 22B are plan views illustrating the second example of the second embodiment according to the present invention. FIG. 22A illustrates the second FPC board 2-b structured to have the wiring (wiring pattern) 2-b1 whose tip is narrowed. The structure of narrowing the tip of the wiring 2-b1 offers continuously tapered formation in FIG. 22A. However, the structure is not limited thereto. For instance, the tip may be tapered stepwise. Solder meniscus 2-ab4′ is formed between the first ant second FPC boards 2-a and 2-b shown in FIG. 21. When the second FPC board 2-b is removed from the first FPC board 2-a, the solder meniscus 2-ab4′ is broken at a certain height, which determines an amount of solder left on each of the FPC boards. The structure of narrowing the tip can render the solder meniscus on the second FPC board 2-b smaller than that on the first FPC board 2-a, thereby enabling a larger amount of solder to be left on the first FPC board 2-a.

### THIRD EXAMPLE

Next, a description is made of a third example of facilitated repair-joint that features the second embodiment of the present invention with reference to FIGS. 23A and 23B. FIGS. 23A and 23B are plan views illustrating the third example of the present invention. The wiring (wiring pattern) 2-b1 of the second FPC board 2-b shown in FIG. 23A has a width narrower than that of the wiring (wiring pattern) 2-a of the first FPC board 2-a shown in FIG. 23B. The structure of narrowing the width of the wiring can enable more solder to be left on the first FPC board. Use of such a first FPC board together with the second FPC board provides a more effective structure.

### FOURTH EXAMPLE

Next, a description is made of a fourth example of facilitated repair-joint that features the second embodiment of the present invention with reference to FIGS. 24A and 24B. FIGS. 24A and 24B are plan views illustrating the fourth example of the present invention. The wiring (wiring pattern) 2-b1 of the second FPC board 2-b has a split end portion as shown in FIG. 24A. The structure of splitting the end portion of the wiring can enable more solder to be left on the first FPC board. Use of such a second FPC board together with the first FPC board provides a more effective structure.

Meanwhile, as performance required for the optical pickup device, reduction in thickness and higher performance capable of reading from and writing to not only CDs but also DVDs compliant to various specifications are desired nowadays. Further, it is expected that a thin optical pickup device having BD/DVD/CD wavelength compatibility and incorporating a blue semiconductor laser will be required to read and write date from and to the next-generation disc in the future. The present invention is applicable to such an expected thin optical pickup device.

In addition, it is expected that a FPC board used in an optical pickup device will need further higher density and will be multilayered, remarkably increasing cost. Examples of means for solving this problem include dividing FPC boards that have been integral with each other and joining them together. In this case, it is needed to fix and protect the joint. The present invention offers the technique relating to joint of FPC boards and can realize an improvement in yield and reduced cost.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. An optical disc drive apparatus comprising:
an optical pickup device main body on which a semiconductor chip component is mounted;
an optical pickup case on which the optical pickup device main body is mounted and which is moved horizontally linearly in a reciprocative manner between inner and outer circumferential sides of an optical disc; and
a first flexible printed circuit board manufactured by being divided from a second flexible printed circuit board and fixed to an upper surface of the optical pickup device main body, the first flexible printed circuit board being formed of a base film, a cover film and a wiring conductor sandwiched between the base film and the cover film, the second flexible printed circuit board being formed of a base film, a cover film and a wiring conductor sandwiched between the base film and the cover film and inserted into a drive side connector;
wherein the wiring conductor located at a first joining end of the first flexible printed circuit board and the wiring conductor of the second flexible printed circuit board located at a second joining end are overlapped each other for positioning at a position near an end of an upper surface of the optical pickup case and bonded together using a bonding material to form a joint; and
wherein the joint is configured such that an end face of the base film at the joining end of at least one of the first and second flexible printed circuit boards extends outward from an end face of the associated wiring conductor.

2. The optical disc drive apparatus according to claim 1, wherein the extension has a length of about 1 mm or more.

3. The optical disc drive apparatus according to claim 1, wherein the first joining end and the second joining end are fixed so as to protect the bonding material with an adhesive.

4. The optical disc drive apparatus according to claim 1, wherein the bonding material is made of solder plating.

5. The optical disc drive apparatus according to claim 1, wherein the wiring conductor of the first flexible printed circuit board has layers more than that of the wiring conductor of the second flexible printed circuit board.

6. The optical disc drive apparatus according to claim 1, wherein the wiring conductor of the second flexible printed circuit board is made of a single layer, whereas the wiring conductor of the first flexible printed circuit board is made of a plurality of layers.

7. The optical disc drive apparatus according to claim 1, wherein the joint is formed by pressing thereto a cover adapted to protect the optical pickup device main body attached to the optical pickup case.

8. An optical disc drive apparatus comprising:
an optical pickup device main body on which a semiconductor chip component is mounted;
an optical pickup case on which the optical pickup device main body is mounted and which is moved horizontally linearly in a reciprocative manner between inner and outer circumferential sides of an optical disc; and
a first flexible printed circuit board manufactured by being divided from a second flexible printed circuit board and fixed to an upper surface of the optical pickup device main body, the first flexible printed circuit board being formed of a base film, a cover film and a wiring conductor sandwiched between the base film and the cover film, the second flexible printed circuit board being formed of a base film, a cover film and a wiring conductor sandwiched between the base film and the cover film and inserted into a drive side connector;
wherein the wiring conductor located at a first joining end of the first flexible printed circuit board and the wiring conductor of the second flexible printed circuit board located at a second joining end are overlapped each other for positioning at a position near an end of an upper surface of the optical pickup case and bonded together using a bonding material to form a joint; and
wherein the joint is configured such that an end face of the base film at the joining end of the first flexible printed circuit boards extends outward from an end face of the associated wiring conductor and an end-face of the base film at the joining end of the second flexible printed circuit boards extends outward from an end face of the associated wiring conductor.

9. The optical disc drive apparatus according to claim 8, wherein the extension has a length of about 1 mm or more.

10. The optical disc drive apparatus according to claim 8, wherein the first joining end and the second joining end are fixed so as to protect the bonding material with an adhesive.

11. The optical disc drive apparatus according to claim 10, wherein the adhesive is a thermosetting adhesive.

12. The optical disc drive apparatus according to claim 8, wherein the bonding material is made of solder plating.

13. The optical disc drive apparatus according to claim 8, wherein the wiring conductor of the first flexible printed circuit board has layers more than that of the wiring conductor of the second flexible printed circuit board.

14. The optical disc drive apparatus according to claim 8, wherein the wiring conductor of the second flexible printed circuit board is made of a single layer, whereas the wiring conductor of the first flexible printed circuit board is made of a plurality of layers.

15. The optical disc drive apparatus according to claim 8, wherein the joint is formed by pressing thereto a cover adapted to protect the optical pickup device main body attached to the optical pickup case.

16. A flexible printed circuit board joint structure having a solder bonding portion formed by solder bonding wiring patterns formed at ends of a pair of divided flexible printed circuit boards,
wherein a solder dam is formed at a leading end of the wiring pattern of at least one of the flexible printed circuit boards in order to ensure a predetermined amount of solder required for re-joint when one of the flexible printed circuit boards is removed from the other flexible printed circuit board by re-heating and melting the solder bonding portion.

17. The flexible printed circuit board joint structure according to claim 16, wherein an end of the wiring pattern of the other flexible printed circuit board is narrowed in the solder bonding portion.

18. The flexible printed circuit board joint structure according to claim 16, wherein a wiring width of the wiring pattern of the other flexible printed circuit board is made narrower than that of the one of the flexible printed circuit boards in the solder bonding portion.

19. The flexible printed circuit board joint structure according to claim 16, wherein at least an end of the wiring pattern of the other flexible printed circuit board is split in the solder bonding portion.

20. A joint structure of flexible printed circuit boards for an optical pickup, having a solder bonding portion formed by solder bonding a first flexible printed circuit board fixed to an optical pickup device main body to a second flexible printed circuit board inserted into a drive side connector,
wherein a solder dam is formed at a leading end of a wiring pattern of at least one of the first and second flexible printed circuit boards in order to ensure a predetermined amount of solder required for re-joint when the other of the first and second flexible printed circuit boards is removed from the one of the first and second flexible printed circuit boards by re-heating and melting the solder bonding portion.

21. The joint structure of flexible printed circuit boards for an optical pickup according to claim 20, wherein an end of the wiring pattern of the other of the first and second flexible printed circuit boards is narrowed in the solder bonding portion.

22. The joint structure of flexible printed circuit boards for an optical pickup according to claim 20, wherein a wiring width of the wiring pattern of the other of the first and second flexible printed circuit boards is made narrower than that of the one of the first and second flexible printed circuit boards in the solder bonding portion.

23. The joint structure of flexible printed circuit boards for an optical pickup according to claim 20, wherein at least an end of the wiring pattern of the other of the first and second flexible printed circuit boards is split in the solder bonding portion.

24. An optical disc drive apparatus comprising:
an optical pickup device main body on which a semiconductor chip component is mounted; and
an optical pickup case on which the optical pickup device main body is mounted and which is moved horizontally linearly in a reciprocative manner between inner and outer circumferential sides of an optical disc;
wherein the joint structure of flexible printed circuit boards for an optical pickup according to claim 20 is placed between the optical pickup device main body and the drive side connector.

25. An optical disc drive apparatus comprising:
an optical pickup device main body on which a semiconductor chip component is mounted; and
an optical pickup case on which the optical pickup device main body is mounted and which is moved horizontally linearly in a reciprocative manner between inner and outer circumferential sides of an optical disc;
wherein the joint structure of flexible printed circuit boards for an optical pickup according to claim 21 is placed between the optical pickup device main body and the drive side connector.

26. An optical disc drive apparatus comprising:
an optical pickup device main body on which a semiconductor chip component is mounted; and
an optical pickup case on which the optical pickup device main body is mounted and which is moved horizontally linearly in a reciprocative manner between inner and outer circumferential sides of an optical disc;
wherein the joint structure of flexible printed circuit boards for an optical pickup according to claim 22 is placed between the optical pickup device main body and the drive side connector.

27. An optical disc drive apparatus comprising:
an optical pickup device main body on which a semiconductor chip component is mounted; and
an optical pickup case on which the optical pickup device main body is mounted and which is moved horizontally linearly in a reciprocative manner between inner and outer circumferential sides of an optical disc;
wherein the joint structure of flexible printed circuit boards for an optical pickup according to claim 23 is placed between the optical pickup device main body and the drive side connector.
